(19) United States
(12) Patent Application Publication
(10) Pub. No.: US 2011/0204718 A1
(43) Pub. Date: Aug. 25, 2011

(54) Power supply arrangement, in particular for supplying power to a reactor for producing polysilicon

(75) Inventors: Peter WALLMEIER, Lippstadt (DE); Wolfgang PAUL, Warstein-Belecke (DE)

(73) Assignee: AEG POWER SOLUTIONS B.V., Zwanenburg (NL)

(21) Appl. No.: 13/032,757

(22) Filed: Feb. 23, 2011

(30) Foreign Application Priority Data
Feb. 23, 2010 (EP) 10 154 318.9

(51) Int. Cl. G05F 1/455

(52) U.S. Cl. 307/31

(57) ABSTRACT

The invention relates to a power supply arrangement, in particular for supplying power to thin silicon rods in a reactor for producing polysilicon with the Siemens process, with inputs (L1, L2, L3) for connection to a three-phase power grid, with outputs, grouped in three groups (A11-A13, A21-A24, A31-A33) of outputs for supplying power to loads connected to the outputs, in particular the thin silicon rods, with three groups (S1, S2, S3) of adjusting means for adjusting an electric voltage present at the outputs, and with three groups (U1, U2, U3) of switchover means for switching between a parallel connection and a series connection of the outputs in one of the groups (A11-A13, A21-A24, A31-A33) of outputs, wherein at least in one state of the power supply arrangement, each group (S1, S2, S3) of adjusting means is connected to a group of outputs (A11-A13, A21-A24, A31-A33) by way of a group of switchover means (U1, U2, U3).

### BACKGROUND OF THE INVENTION

(1) Field of the Invention

The present invention relates to a power supply arrangement, in particular for supplying power to thin silicon rods in a reactor for producing polysilicon with the Siemens process, with inputs for connection to a three-phase power grid, with three groups of outputs for supplying power to loads connectable to the outputs, in particular the thin silicon rods, with three groups of adjusting means for adjusting an electric voltage applied at the outputs, and with three groups of switchover means for changing between a parallel connection and a series connection of the outputs of one of the groups of outputs, wherein at least in one state of the power supply arrangement, each group of adjusting means is connected to a group of outputs by way of a group of switchover means.

An output in a power supply arrangement of this type is a pair of electrical terminals configured for connection of one or more serially connected loads. If a load is connected to the output, then in at least one state of the current supply arrangement, a current can flow from one terminal to the other terminal via the load. However, states of the current supply arrangement may also exist where current does not flow from one of the terminals of an output to the other terminal. A connection of one output may also be a connection of at least one additional output.

If in one state of the current supply arrangement several outputs are connected in parallel, then this means that the outputs in this state of the current supply arrangement are connected to the same current source in the current supply arrangement. If loads are connected to the parallel-connected outputs, then these loads are also connected in parallel.

Conversely, if in one state of the current supply arrangement several outputs are connected in series, then a voltage drop occurs in this state across all serially-connected outputs. If loads are connected to the serially-connected outputs, then a current flows from a first terminal of a first output of the series connection through the loads to a second terminal of a last output of the series connection. No current flows via the other terminals of the serially-connected outputs.

(2) Description of Related Art

The European patent application EP 1 947 545 A2 discloses in FIG. 2a current supply arrangement for supplying power to thin silicon rods in a reactor in order to produce polysilicon with the Siemens process. Thin silicon rods are combined into rod pairs, forming the loads connected to the current supply arrangement.

The current supply arrangement has three groups of outputs, wherein the outputs of these three groups can be connected in a parallel connection or a series connection. If the outputs of a group of outputs are connected in series, then the rod pairs connected to the outputs of this group are also connected in series. Conversely, if the outputs are connected in parallel, then the rod pairs are also connected in parallel. In addition to these three groups of outputs, the current supply arrangement has an additional output. Overall, 18 rod pairs can be supplied with electric energy by using a current supply arrangement according to FIG. 2 of the European patent application EP 1 947 545 A2.

The rod pairs are arranged in the reactor in form of three concentric rings, wherein three rod pairs are arranged in an inner ring, six rod pairs in a center ring, and nine rod pairs in an outer ring. A total of six rod pairs are supplied with electric energy via each of the three inputs of the three-phase current supply arrangement, which is realized by supplying electric energy from one phase to the three rod pairs of the inner ring and three rod pairs of the outer ring. This leads to a high degree of complexity of the group of adjusting means, to which these rod pairs are connected.

### BRIEF SUMMARY OF THE INVENTION

It was therefore an object of the invention to provide a simple current supply arrangement of the aforedescribed type, which is suitable for supplying power to rod pairs arranged in a reactor in two concentric rings. In particular, the current supply arrangement should be suitable and configured to supply power to 18 rod pairs.

This object is attained with the invention by grouping all outputs into three groups of outputs.

With the current supply arrangement according to the invention, electric energy can be supplied to 18 rod pairs arranged in a reactor in two concentric rings. The partition can be performed such that a first group of outputs is provided for supplying power to the rod pairs of the inner ring, whereas the other two groups are provided for supplying power to the rod pairs of the outer ring. However, the use of the current supply arrangement according to the invention is not limited to this situation.

A current supply arrangement according to the invention can be configured such that in at least one state of the current supply arrangement, each group of adjusting means is connected to exactly one group of outputs via exact the one group of switchover means. Preferably, this is the situation when the outputs of the group are connected in parallel. However, each group of adjusting means may preferably also be connected to an input via exactly one transformer. With this unambiguous association of the group of adjusting means, switchover means and outputs as well as the transformers, a simple control structure for controlling the power transmitted via the outputs is feasible.

The current supply arrangement according to the invention may have at least one first group of outputs of the groups of outputs, wherein three outputs may be operated in a parallel connection or in a series connection. Two serially connected loads can then be connected to each output. Half of the voltage present at the respective output then drops across each load. Preferably, a current supply arrangement according to the invention has exactly one first group of outputs. However, according to the invention, all three groups of outputs may each have three outputs which can be operated in a series connection or in a parallel connection.

In addition, a current supply arrangement according to the invention may have at least one second group of outputs of the groups of outputs, wherein two outputs can be operated in a parallel connection or in a series connection. Three loads can then be connected to each output. In a parallel connection of the outputs of the second group, the voltage drop is then one third of the voltage present at the output. Preferably, a power supply arrangement according to the invention has exactly two second groups of outputs. However, according to the invention, all three groups of outputs may have two outputs which can be operated in a series connection.

The groups of adjusting means of a power supply arrangement according to the invention may have input-side terminals. These may each be connected to a tap of a secondary side of the transformer connected to the group of adjusting means. By way of the taps, different voltages can be applied on the input-side of the group of adjusting means.

The groups of adjusting means may have a first output-side terminal and a second output-side terminal. Each output-side terminal may be connected to at least two input-side terminals via a power control device. With this type of connection of the output-side terminals, a voltage at the output-side terminals of the groups of adjusting means can be adjusted in two ways. A first step-wise adjustment of the voltage is possible by selecting the input-side terminal connected to the output-side terminal via a power controller. A second, preferably continuous adjustment is possible by selecting a firing angle of the power control device. In this way, continuously adjustable voltages can be applied to the output-side terminals of each group of adjusting means with a voltage follower control.

Because the first output-side terminal of the power supply arrangement operates to supply power to the outputs in a parallel connection of the outputs and the second output-side terminal operates to supply power to the outputs in a series connection of the outputs, the voltage at the outputs of a group of outputs can be additionally varied. Whereas with a parallel connection of the outputs, a full maximum voltage is provided at the first output-side terminals of the corresponding group of adjusting means, with a series connection the maximum voltage at the outputs of a group of outputs is only a fraction of the voltage present at the second output-side terminal of the associated group of adjusting means. This fraction is determined by the number of serially connected outputs in the group.

In a power supply arrangement according to the invention, each group of switchover means may have an input-side terminal. The input-side terminal is preferably connected to the first output-side terminal of the associated group of adjusting means. The voltage at the input-side terminals of the groups of switchover means can then be continuously adjusted.

Each group of switchover means may have output-side terminals which are directly connected to the return line connection of the associated transformer, or which may be connected to the group of switchover means, optionally via controllable switching means, to the first input-side terminal or to a return line terminal of the associated transformer.

A power supply arrangement according to the invention may be configured such that the second output-side terminals of the groups of adjusting means, the output-side terminals of the groups of switchover means and return line terminals of the transformers are connected to terminals of the outputs of the associated groups of outputs.

In an advantageous embodiment of the power supply arrangement of the invention, each second output-side terminal of a group of adjusting means may be connected to a second output-side terminal of the associated groups of switchover means via a node in the associated group of switchover means. The second output-side terminal can then be indirectly connected to terminals of the outputs of the associated group of outputs by way of the output-side terminals of the groups of switchover means and the terminals to the return lines.

A reactor according to the invention for producing polysilicon with the Siemens process has a power supply arrangement according to the invention and thin silicon rods arranged in the reactor, wherein the thin silicon rods are connected to the outputs of the current supply arrangement. Two serially connected thin silicon rods forming a load may be connected in one-to one correspondence to respective outputs of the first group, whereas three serially connected thin silicon rods forming a load may be connected in one-to one correspondence to respective outputs of the second group of outputs. Preferably, the power supply arrangement has one first group of outputs and two second groups of outputs. The rod pairs connected to the first group of outputs may be connected in an inner ring, and the rod pairs connected to the second groups may be connected to a second ring.

A reactor of this type can be operated as follows:
in a first step, a voltage is applied with a parallel connection to the outputs of the first group of outputs and the loads connected thereto, whereas no voltage is applied to the loads connected to the outputs of the second groups of outputs, and
in a later step, a voltage is applied with a series connection to the outputs of the first group of outputs and the loads connected thereto and to the outputs of the second groups of outputs and the loads connected thereto.

During the first step, current flows through the loads connected to the outputs of the first group of outputs. The rod pairs heat up and lose a significant portion of their electrical resistance when reaching a known temperature. This is referred to as ignition of the rod pairs. With the voltage still applied, current continues to flow through the rod pairs. Half of the voltage applied across the associated output drops across each rod pair.

The heat-up of the loads connected to the outputs of the first group radiates to the loads connected to the outputs of the second groups of outputs. These rod pairs are preheated by the radiant heat. In a step preceding the later step, voltage may be applied to the outputs of the second groups of outputs and the preheated loads connected thereto in a parallel connection. Because three rod pairs are connected to each output of the second group, the voltage drop across each rod pair is one third of the voltage across the output. However, this third is sufficient to further heat and also fire the preheated loads. During this time, a voltage may stay applied to the outputs of the first group of outputs and the loads connected thereto in a parallel connection. However, a voltage may also be applied during this time to the outputs of the first group of outputs and the loads connected thereto in a series connection.

It is also feasible to apply a voltage to the outputs of the second groups of outputs and the loads connected thereto in series connection, while a voltage is applied to the loads connected to the outputs of the first group in a parallel connection.

### BRIEF DESCRIPTION OF THE DRAWING

Additional features and advantages of the present invention will become clear from the following description of an exemplary embodiment illustrated in the drawing. It is shown in:

FIG. 1a schematic circuit diagram of a power supply arrangement according to the invention.

### DETAILED DESCRIPTION OF THE INVENTION

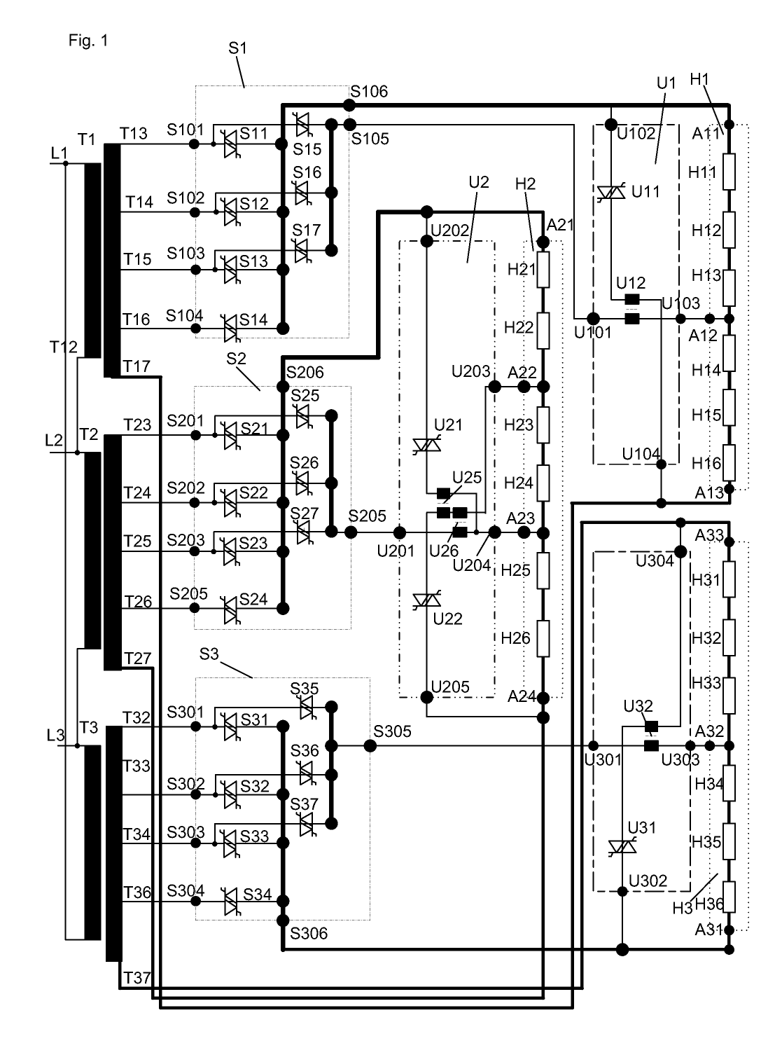

The power supply arrangement illustrated in FIG. 1 has three inputs L1, L2, L3 connected to three transformers T1, T2, T3 in a Delta connection. The secondary sides of the three transformers T1, T2, T3 are connected in one-to-one correspondence to a group S1, S2, S3 of adjusting means. A respective group U1, U2, U3 of switchover means is connected to each group S1, S2, S3 of adjusting means. In addition, a group of outputs is connected to each group S1, S2, S3 of adjusting means and to each group U1, U2, U3 of switchover means. A group H1, H2, H3 of loads is connected to each group of outputs.

During the operation of the power supply arrangement, a current supplying the loads of the group of loads flows via the transformers T1, T2, T3, the groups S1, S2, S3 of adjusting means and the groups of the outputs.

The transformers T1, T2, T3 and the groups S1, S2, S3 of adjusting means are constructed identically. They will be described in more detail with reference to the transformer T1 and the group S1 of adjusting means connected thereto.

The secondary side of the transformer T1 has four taps T13, T14, T15, T16. These taps T13, T14, T15, T16 of the transformer T1 are connected to input-side terminals S101, S102, S103, S104 of the group S1 of adjusting means. Within the group S1 of adjusting means, the input-side terminals S101, S102, S103 are connected in one-to-one correspondence to two corresponding power control devices S11, S15, S12, S16, S13, S17 via a respective node, whereas the input-side terminal S104 is connected to a power control device S14. The power control devices S15, S16, S17 are connected to a first bus bar, while the power control devices S11, S12, S13, S14 are connected to a second bus bar. The first bus bar is connected to a first output-site terminal S105 and the second bus bar is connected to a second output-side terminal S106 of the group S1 of adjusting means.

In the same manner, taps T23, T24, T25, T26, T33, T34, T35, T36 of the transformers T2, T3 are connected to input-side terminals S201, S202, S203, S204, S301, S302, S303, S304 of the group S2, S3 of adjusting means. Within these groups S2, S3 the input-side terminals S201, S202, S203, S204, S301, S302, S303, S304 are connected in the same manner to first output-side terminals S205, S305 and second output-side terminals S206, S306 via power control devices S21, S25, S22, S26, S23, S27, S24, S31, S35, S32, S36, S33, S37, S34 and a first and a second bus bar.

The first output-side terminal S105 is connected to an input-side terminal U101 of the associated group U1 of switchover means, whereas the second output-side terminal is connected to a terminal A11 of the first group A11 to A13 of outputs. Likewise, the first output-side terminals S205, S305 of the groups S2, S3 are connected to input-side terminals U201, U301 of the associated group U2, U3 of switchover means. The second output-side terminals S206, S306 of the groups S2, S3 are connected to terminals A21, A31 of the groups A21 to A24, A31 to A33 of outputs.

In addition to the terminals A11, A21, A31, the groups of outputs have additional terminals A12, A13, A22, A23, A24, A32, A33. Each terminal together with another terminal of the same group is at least part of an output. The terminal pair A11 and A12 and the terminal pair A12 and A13 form the outputs of the first group of outputs. The terminal pair A21 and A22, the terminal pair A22 and A23 and the terminal pair A23 and A24 form the outputs of the second group of outputs. The first and the third group of outputs have two outputs. The second group has three outputs.

The terminals A13, A24, A33 are connected to taps T17, T27, T37 of the associated transformers T1, T2, T3 via a return line.

If the outputs are connected in series, the entire voltage across the second output-side terminal S106, S206, S306 of the groups S1, S2, S3 drops between the terminal A11 and the terminal A13, the terminal A21 and the terminal A24, and the terminal A31 and the terminal A33. In this situation, no voltage must be present at the first output-side terminals S105, S205, S206.

While the groups U1, U3 of switchover means are constructed identically, the group U2 is constructed differently. The reason herefor is that the groups U1, U3 of switchover means are provided for the parallel connection of the two outputs of the first and third groups, whereas the group U2 is suitable and configured for the parallel connection of the three outputs of the second group.

In addition to the input-side terminals U101, U301, the groups U1, U2 of switchover means have terminals U102, U103, U104, U202, U203, U204 which are connected to the terminals A11, A12, A13, A31, A32, A33. As a result, a voltage can be applied in parallel to the outputs of the first and the third groups of outputs formed by the terminal pairs A11, A12; A12, A13 and/or A31, A32; A32, A33 via the terminals U102, U103, U104, U202, U203, U204.

The terminals U103, U303 are connected to the terminals A12, A32 of the outputs and to the input-side terminals U101, U301 via interconnected first coils of coupling means U12, U32. A voltage at the input-side terminals U101, U301 is therefore also present at the terminals U103, U303 and the terminals A12, A32.

The terminals U102, U302 are connected to the terminals A11, A31 and to the terminals U104, U304 via interconnected switches U11, U31 and second coils of the coupling means U12, U32.

The terminals U104, U304 are also connected to the terminals A13, A33 and to the return line terminals T17, T37 of the transformers T1, T3.

When the controlled switches U11, U31 are closed, the terminals U102, U302 and the terminals A11, A31 are connected to the return line terminals T17, T37 of the transformers T1, T3. The outputs of the first and the third groups of outputs formed by the terminal pairs A11, A12; A12, A13 and/or A31, A32; A32, A33 are then connected in parallel. No voltages must be present at the second output-side terminals S106, S306.

The coupling means U12, U32 are transformers, wherein currents to the parallel-connected outputs flow through the first coil and a current from one of the outputs flow through the second coil. With a suitable design of the transformer familiar to a person skilled in the art, the sum of the currents to the parallel-connected outputs can be set to be twice the current from the one output.

The group U2 of switchover means is different because the three outputs of the second group of outputs can be connected in parallel, whereas two outputs can be connected in parallel in the other groups U1, U3. In addition to the input-side terminal U201, the group U2 has terminals U202, U203, U204, U205 which are connected to the terminals A21, A22, A23, A24 of the outputs of the second group. The terminals U202, U204 and hence the terminals A21, A23 are connected via a controlled switching means U21 with the input-side terminal U201, so that when the switching means U21 is closed, the same voltage is present at the terminals A21, A23 as at the first output-side terminal S205 of the group S2 of adjusting means.

The terminal U205 is connected to the terminal A24 and to a return line terminal T27 of the transformer T2. The terminal A24 therefore always has the potential of the return line terminal T27. The terminal U203 is connected to the terminal A22 and via a control switchover means U22 to the terminal U205 and hence also to the return line terminal T27. When the switching means U22 is closed, the terminal A22 is also at the potential of the return line terminal T27.

If the outputs of the group A2 formed by the terminal pair A21, A22, the terminal pair A23, A22, and the terminal pair A23, A24 are connected in parallel, then the switching means U21, U22 are closed. If the outputs of the group A2 are connected in series, then the switching means are open, so that the voltage at the second output-side terminal S206 drops across the series connection of the outputs.

The group U2 of switchover means also includes coupling means U25, U26 which operates to ensure that the currents through the outputs have always identical magnitude.

1. A power supply arrangement for supplying power to thin silicon rods in a reactor for producing polysilicon with the Siemens process, the power supply arrangement comprises
inputs (L1, L2, L3) for connection to a three-phase power grid,
outputs grouped in three groups (A11-A13, A21-A24, A31-A33) of outputs for supplying power to loads connectable to the outputs, in particular the thin silicon rods,
three groups (S1, S2, S3) of adjusting means for adjusting an electric voltage present at the outputs, and
three groups (U1, U2, U3) of switchover means for switching between a parallel connection and a series connection of the outputs of one of the groups (A11-A13, A21-A24, A31-A33) of outputs,
wherein each group (S1, S2, S3) of adjusting means is connected at least in one state of the power supply arrangement to a group of outputs (A11-A13, A21-A24, A31-A33) by way of a group of switchover means (U1, U2, U3).

2. The power supply arrangement according to claim 1, wherein in one state of the power supply arrangement, each group (S1, S2, S3) of adjusting means is connected to exactly one group (A11-A13, A21-A24, A31-A33) of outputs by way of exactly one group (U1, U2, U3) of switchover means.

3. The power supply arrangement according to claim 1, wherein each group (S1, S2, S3) of adjusting means is connected to an input (L1, L2, L3) via one transformer (T1, T2, T3).

4. The power supply arrangement according to claim 1, wherein at least a first group (A21-A24) of outputs of the groups (A11-A13, A21-A24, A31-A33) of outputs has three outputs (A21, A22; A23, A22; A23, A24), which can be operated in a parallel connection or a series connection.

5. The power supply arrangement according to claim 1, wherein at least one second group (A11-A13, A31-A33) of outputs of the groups (A11-A13, A21-A24, A31-A33) of outputs comprises two outputs (A12, A11; A12, A13 and/or A32, A31, A32, A33), which are operated in a parallel connection or a series connection.

6. The power supply arrangement according to claim 3, wherein the groups (S1, S2, S3) of adjusting means having input-side terminals (S101 to S104, S201 to S204, S301 to S304) are each connected to a corresponding tap (T13 to T14, T21 to T24, T31 to T34) of a secondary side of the transformer (T1, T2, T3) connected to the group (S1, S2, S3) of adjusting means.

7. The power supply arrangement according to claim 6, wherein the groups (S1, S2, S3) of adjusting means have a first output-side terminal (S105, S205, S305) and a second output-side terminal (S106, S206, S306), and each output-side terminal (S105, S106, S205, S206, S305, S306) is connected to at least two input-side terminals (S101 to S104, S201 to S204, S301 to S304) via a power control device (S11 to S17, S21, S27, S31 to S37).

8. The power supply arrangement according to claim 7, wherein each group (U1, U2, U3) of switchover means has an input-side terminal (U101, U201, U301), wherein the input-side terminal (U101, U201, U301) is connected to the first output-side terminal (S105, S205, S305) of the associated group (S1, S2, S3) of adjusting means.

9. The power supply arrangement according to claim 8, wherein each group (U1, U2, U3) of switchover means has output-side terminals (U102 to U104, U202 to U205, U302 to U304) which are connected to the first input-side terminal or to a return line terminal (T17, T27, T37) of the associated transformer (T1, T2, T3).

10. The power supply arrangement according to claim 9, wherein the second output-side terminals (S106, S206, S306) of the groups (S1, S2, S3) of adjusting means, the output-side terminals (U102 to U104, U202 to U205, U302 to U304) of the groups of switchover means (U1, U2, U3) and return line terminals (T17, T27, T37) are connected to terminals (A11-A13, A21-A24, A31-A33) of the outputs of the groups of outputs.

11. A reactor for producing polysilicon with the Siemens process, wherein the reactor has a power supply arrangement according to claim 1 and thin silicon rods (H11 to H16, H21 to H26, H31 to H36) arranged in the reactor, which are connected to the outputs of the power supply arrangement.

12. The reactor according to claim 11, wherein two thin silicon rods, which are connected in series and form a load (H21, H22; H23, H24; H25, H26), are connected to outputs of the first group of outputs in one-to-one correspondence, and three thin silicon rods, which are connected in series and form a load (H11 to H13; H14 to H16; H31 to H33; H34 to H36), are connected to the outputs of the second group of outputs in one-to-one correspondence.

13. A method for operating a reactor according to claim 11, comprising the steps of applying, in a first step, a voltage to the outputs of the first groups of output and connecting the loads (H21, H22; H23, H24; H25, H26) thereto in a parallel connection, whereas no voltage is present at the loads (H11 to H13; H14 to H16; H31 to H33; H34 to H36) connected to the outputs of the second group of outputs, and applying, in a later step, a voltage to the outputs of the first group of the outputs and connecting the loads (H21 to H26) thereto and the outputs of the second group of outputs and the loads (H11 to H16; H31 to H36) in a series connection.

14. The method according to claim 13, wherein in a second step preceding the later step, a voltage is applied to the outputs of the first group of outputs and the loads (H21, H22; H23, H24; H25, H26) connected thereto, and to the outputs of the second group of outputs and the loads (H11 to H13; H14 to H16; H31 to H33; H34 to H36) connected thereto in a parallel connection.

15. The method according to claim 13, wherein in a third step preceding the later step and following the first and/or the second step, a voltage is applied to either the outputs of the first group of outputs and the loads (H11 to H16; H31 to H36) connected thereto or to the outputs of the second group of outputs and the loads (H11 to H16; H31 to H36) connected thereto in a series connection, whereas a voltage is applied to the loads connected to the other outputs in a parallel connection.
